(19) United States
(12) Patent Application Publication
(10) Pub. No.: US 2025/0141146 A1
(43) Pub. Date: May 1, 2025

(54) ELECTRICAL CONNECTOR ASSEMBLY AND METHOD FOR ASSEMBLING SAME

(71) Applicant: Aptiv Technologies AG, Schaffhausen (CH)

(72) Inventors: Vijendran PERUMALSAMY, Aravakurichi (IN); Udo RAMAEKERS, Schwelm (DE)

(21) Appl. No.: 18/929,751

(22) Filed: Oct. 29, 2024

(30) Foreign Application Priority Data
Oct. 30, 2023 (EP) 23206710.8

(51) Int. Cl. H01R 13/426; H01R 13/506; H01R 13/64

(52) U.S. Cl. CPC H01R 13/426; H01R 13/506; H01R 13/64

(57) ABSTRACT

The disclosure presents an electrical connector assembly including a connector housing for receiving electrical terminals, a terminal position assurance (TPA) member mounted to the connector housing and movable between pre-locked and final locked positions, and an actuating member mounted to the connector housing and movable between first and second positions parallel to the terminals' receiving direction. The actuating member is designed to move the TPA member from the pre-locked to the final locked position when transitioning from its first to the second position. This innovative assembly provides enhanced functionality and ease of use in securing electrical terminals within the connector housing.

### CROSS-REFERENCE TO RELATED APPLICATION

This application claims the benefit of and priority to European Patent Application No. 23206710.8 on Oct. 30, 2023, the contents of which are incorporated by reference herein.

### TECHNICAL FIELD

This disclosure relates to an electrical connector assembly with a terminal position assurance (TPA) member, as well as to a method for assembling a connector assembly.

### BACKGROUND

Electrical connectors and electrical connector assemblies are commonly used to connect various cables, such as for example telecommunication cables, common networking cables, signaling cables or in general any electrical wiring. In this context electrical connectors are particularly used for joining electrical circuits, wherein a male ended plug of an electrical connector may be configured to be connected to a respective female ended jack of a corresponding counter connector.

Many electrical connector assemblies are provided with a so-called terminal position assurance (TPA) device, which allows for assuring that a terminal or contact is fully inserted into an electrical connector housing to form the electrical connector. To such an electrical connector, a corresponding connector may be mated from an end opposite to and end at which the terminal is inserted.

A TPA device, alternatively referred to as a TPA member, is often utilized for electrical connectors to detect incomplete insertion of contact terminals into a connector housing. They also assist in assuring that the contact terminals are properly positioned in the respective housing. A TPA member may thereby be mounted movably to the connector housing and may secure the terminal within the connector housing when fully inserted.

Conventional electrical connectors typically employ TPA devices that are external parts and that need to be assembled after electrical terminals are in position of the connector to fix the positioning thereof. Such external TPA devices have several disadvantages. For instance, accessibility of these TPA devices is not optimal. Moreover, keeping a water tightness of the connector may become difficult and the assembly steps are usually complex, as a plurality of distinct parts are necessary to be assembled.

It is thus an object of the disclosure to provide an electrical connector assembly which overcomes the above outlined disadvantages at least partially. It is in particular an object of the disclosure to provide an electrical connector assembly having a TPA functionality, whereby the TPA function can be provided with improved accessibility for the user, with an improved water tightness and by reducing the number of assembly steps of the user. Overall, the TPA functionality should be easy to be performed by a user without requiring much effort or personnel.

### SUMMARY

In one aspect, an electrical connector assembly includes a connector housing configured to receive one or more electrical terminals, a terminal position assurance, TPA, member configured to be mounted to the connector housing and being movable relative to the connector housing between a pre-locked position and a final locked position when mounted, and an actuating member configured to be mounted to the connector housing and being movable relative to the connector housing between a first position and a second position when mounted, wherein the movement between first and second position is essentially parallel to the receiving direction of the one or more electrical terminals; wherein when moving from the first position to the second position the actuating member is configured to move the TPA member from the pre-locked position to the final locked position.

The connector housing may thereby include at least one aperture which is configured to receive the one or more electrical terminals or also termed one or more contact terminals therein. The housing may form the main housing of the connector and may in general have any shape configured to be connected to a corresponding counter connector. It is not precluded according to the present disclosure that the connector housing also include means for locking the housing to the corresponding counter connector.

The electrical connector assembly further includes a terminal position assurance, (TPA) member which is configured to be mounted to the connector housing, and which is movable relative to the connector housing between a pre-locked position and a final locked position when the TPA member is in a mounted condition with the connector housing. As described elsewhere herein, the TPA member is typically pre-mounted to the connector housing. The TPA member may thereby provide TPA functionality to the electrical connector assembly. This may mean that it facilitates securing and/or locking the positioning of the one or more electrical terminals within the connector housing when the TPA member is in the final locked position. When the TPA member is in the pre-locked position, the TPA member may facilitate insertion or removal of the one or more electrical terminals. By moving the TPA member between the pre-locked position and the final locked position, the locking function of the TPA member for the one or more electrical terminals can be set and unset. In one example, the movement of the TPA member between the pre-locked and final locked position is a linear movement with respect to its direction. However, it is not precluded that the movement is non-linear. The direction of movement of the TPA member may be along a lateral direction relative to the connector housing. The skilled person may be aware of determining the lateral direction when looking at the connector housing.

The electrical connector assembly further includes an actuating member which is configured to be mounted to the connector housing, and which is movable relative to the connector housing between a first position and a second position when the actuating member is in a mounted condition. The actuating member may, in one example, only move between the first position and second position in mounted condition. As understood, a plurality of different position between the first and the second position may be possible. Preferably the movement of the actuating member between the first and second position is a linear movement with respect to its direction. However, it is not precluded that the movement of the actuating member between the first and second position is non-linear.

The movement of the actuating member between the first and the second position is essentially parallel to the receiving direction of the one or more electrical terminals. The receiving direction may be substantially parallel to and/or the same as a longitudinal direction, such as a longitudinal direction of the one or more electrical terminals. The receiving direction may be substantially parallel to and/or the same as a mating direction. The mating direction may be understood as the direction in which the connector housing is mated with another connector part, e.g., from a side opposite to a side at which the electrical terminals are received. In one example, the actuating member may be a sliding element or a slider, which is configured to be guided along the one or more electrical terminals, as described elsewhere herein in greater detail.

The actuating member is configured to move the TPA member from the pre-locked position to the final locked position, when the actuating member is moving from the first position to the second position. Thereby, merely by moving the actuating member from the first position to the second position, the TPA member may advantageously be moved indirectly between the pre-locked position and the final locked position. Thereby, it may be understood that the movement of the TPA member may be triggered by the movement of the actuating member. This simplifies the locking of the one or more electrical terminals.

In view of the foregoing, it is understood that when the TPA member is mounted to the connector housing, the movement thereof can be easily controlled by moving the actuating member, which is also mounted to the connector housing.

In this manner, the present disclosure provides an improved electrical connector assembly and in particular an improved TPA functionality. In particular, the TPA member may be able to be mounted to the connector housing already before the one or more electrical terminals are inserted. Thus, for instance a wiring harness manufacturer and/or original equipment manufacturer (OEM) may easily move the TPA member inside the connector housing without having to remove and/or assemble the connector housing. This provides the advantage that sealing of the overall electrical connector assembly, such as a water tightness of the overall electrical connector assembly can be improved. This is for instance advantageous when considered prior art TPA members, which are assembled after electrical terminals are inserted into the connector housing. Among other features, in particular the movement of the actuating member between first position and second position being essentially parallel to the receiving direction of the one or more electrical terminals may allow for the advantages mentioned in here. Furthermore, the TPA member has the advantage that it can be indirectly and easily accessed. Further, it may allow using assorted sizes of electrical terminals. In addition, several types of electrical terminals may be employed, for instance, electrical terminals provided by stamping, machining, cold forming, just to name a few in a non-exhaustive list of examples.

The TPA member, the connector housing and/or the actuating member may be of any kind of suitable material. Preferably, the TPA member, the connector housing and/or the actuating member may be made of a polymer and may preferably be injection-molded polymer components.

In a preferred embodiment of the electrical connector assembly, the TPA member is pre-mounted to the connector housing, before the one or more terminals are received within the connector housing. Pre-mounting may not be possible for conventional prior art TPA members, which are typically provided as external parts as understood by the skilled person. The pre-mounted TPA member facilitates assembling of the respective parts and makes it easier to maintain a needed sealing functionality of the electrical connector assembly.

In a preferred embodiment of the electrical connector assembly, the connector housing includes one or more fixing elements and/or recesses arranged to engage with corresponding recesses and/or fixing elements of the one or more terminals, respectively. As understood by the skilled person, for this substantially allows for fixing the connector housing with the one or more terminals. In this manner, it may be encompassed that the connector housing includes one or more fixing elements arranged to engage with corresponding recesses of the one or more terminals. Further, it is encompassed that the connector housing includes one or more recesses that are arranged to engage with corresponding fixing elements of the one or more terminals. Fixing elements may be implemented in various way including but not limited to protrusions, extending portions, snap elements, or the like.

In a preferred embodiment of the electrical connector assembly, the TPA member includes at least one projection and the actuating member includes at least one tapered surface shaped in correspondence to the projection for engaging with the projection when the actuating member is moving between the first position and the second position.

In one example, the tapered surface may also be understood as a cut-out made in a material of the actuating member and or a recess provided in the actuating member. Accordingly, the projection and the tapered surface are interacting with each other, to facilitate that the TPA member is moved when the actuating member is being moved from the first position to the second position.

In a preferred embodiment of the electrical connector assembly, the projection includes a cam surface configured to engage with the tapered surface of the actuating member, wherein the surfaces are inclined with respect to the movement between first and second position.

A cam surface may be understood as a specially shaped surface on a moving, contacting, rotating and/or sliding component. The cam surface may be designed to interact with another component. In the present disclosure, the tapered surface may be the part that imparts the motion to the cam surface, such as a cam follower in the present disclosure. The cam surface may have any suitable shape to allow for transmitting a movement. Further, the cam surface may be designed in such a manner that mechanical integrity, durability and robustness is improved. Diverse types of cam surfaces are encompassed in the present disclosure including, but not limited to, one or more of the following: a uniform motion cam surface, which may be designed to produce uniform motion, meaning the moved part moves at a constant velocity as it contacts the moving part. A harmonic motion cam surface, such that motion is imported in a substantially sinusoidal or oscillatory manner. A dwell cam surface, such that at some point of movement of the actuating member, there is no motion of the TPA member, allowing the TPA member to remain stationary for a period before moving again. Further examples are pear cam surfaces, heart cam surface, cylindrical cam surfaces, or the like.

The respective surfaces are inclined with respect to the movement between the first and the second position. The angle of inclination may influence the movement of the TPA member. In some instance, a large angle (e.g., greater than 45°, greater than 50°, or greater than) 60° may be desired, which may mean that a large movement of the TPA member is provided by a small movement of the actuating member. Alternatively, the angle of inclination may be small (e.g., less than 45°, less than 30°, or less than) 20° to allow to finetune movement of the TPA member.

In a preferred embodiment of the electrical connector assembly, the projection of the TPA member projects in a direction substantially parallel to the receiving direction of the one or more electrical terminals. This facilitates moving the TPA member from the pre-locked position to the final locked position upon movement of the actuating member along the receiving direction. The projection of the TPA member may extend substantially perpendicular from a plate portion of the TPA member as described elsewhere in greater detail.

In a preferred embodiment of the electrical connector assembly, the projection of the TPA member is sliding along the tapered surface of the actuating member when the actuating member is moving between the first position and the second position. This allows for a direct engagement of the actuating member on the TPA member. Sliding may be understood as contacting or touching. Preferably the main direction of the tapered surface and the projection is angled relative to the movement direction of the actuating member. The movement direction of the TPA member may thereby be defined by the movement of the actuating member between the first and second position. The movement direction of the TPA member between the pre-locked position and the final locked position may thereby be accurately influenced by the shape of the projection and the tapered surface. In addition, movement may be fine-tuned by the angle of inclination. For example, the TPA member may be a lateral TPA member, which performs a lateral movement relative to the receiving direction of the electrical terminals, when the movement direction of the actuating member is parallel to the receiving direction.

In a preferred embodiment of the electrical connector assembly, the TPA member includes a locking portion arranged to engage with the one or more electrical terminals in the final locked position for substantially fixing the one or more electrical terminals. This may facilitate locking of the one or more electrical terminals once the TPA member is brought from the pre-locked position to the final locked position.

In a preferred embodiment of the electrical connector assembly, the actuating member includes one or more openings shaped in correspondence to the one or more electrical terminals such that the movement of the actuating member between first and second position is essentially parallel to the receiving direction of the one or more electrical terminals. The openings facilitate that the one or more electrical terminals can be easily moved along the receiving direction without much effort for the user. Thereby, the movement between the first and second position is substantially predetermined. This provides for a substantially fail-safe movement, which is appreciated by the user. The openings may adopt any suitable shape. They may be shaped such that the actuating member is not touching the one or more electrical terminals upon movement. However, touching is not precluded in the present disclosure and in some instance, it is specifically desired.

In a preferred embodiment of the electrical connector assembly, the actuating member includes one or more guiding rails arranged along the receiving direction of the one or more electrical terminals to engage with one or more correspondingly shaped guiding protrusions arranged at an inner periphery of the connector housing. The guiding rails allow the movement of the actuating member to be further defined by way of its geometrical shape. This further contributes to a fail-safe arrangement and a simplified construction. Alternatively, the actuating member may include guiding protrusions, and the inner periphery of the connector housing may include one or more guiding rails arranged along the receiving direction of the one or more electrical terminals.

In a preferred embodiment of the electrical connector assembly, the actuating member includes one or more snap elements arranged to engage with one or more apertures arranged at an inner periphery of the connector housing, wherein the snap elements are preferably arranged at an end of the actuating member in the receiving direction that abuts with the TPA member in the second position. This has the advantage of substantially fixing actuating member to the connector housing in the second position. This also facilitates an overall firm construction and prevents further unintended movement after the actuating member has been brought into the second position. The snap elements may include latches, noses, clips, or the like.

In a preferred embodiment of the electrical connector assembly, the TPA member includes at least one sliding means for sliding between the pre-locked position and the final locked position and at least one fixing means for fixing the TPA member to the connector housing in the final locked position. This facilitates movement of the TPA member between the pre-locked position and the final locked position. In particular, the sliding means enable that the TPA member may be provided in a pre-mounted state before receiving the one or more electrical terminals.

In a preferred embodiment of the electrical connector assembly, the TPA member includes a plate portion that extends in a plane perpendicular to the receiving direction of the one or more terminals, the plate portion including one or more openings configured to receive the one or more electrical terminals, wherein the openings preferably have inner contours configured to interact with a locking contour of the one or more electrical terminals for substantially fixing the one or more electrical terminals. The fixing may be releasably in some instances, if desired.

A plate portion may be, for instance, different than a U-shaped form or the like. The plate portion may be substantially planar and rectangular. The plate portion may be substantially flat. As understood, the plate portion includes one or more openings, nevertheless, the shape of the TPA member may still be regarded as being substantially planar and/or rectangular. Same applies to the at least one projection of the TPA member. The plate portion may thereby provide the TPA functionality. The inner contours may include a locking portion of the TPA member as described elsewhere herein. The inner contours may be provided with a ticker material or a material which possesses a greater strength. This facilitates locking of the one or more electrical terminals by way of the TPA member.

In a preferred embodiment of the electrical connector assembly, the movement of the actuating member between the first and second position is perpendicular to the movement of the TPA member between the pre-locked and the final locked position.

In a preferred embodiment of the electrical connector assembly, the assembly includes plurality of electrical terminals, wherein the TPA member includes a plurality of openings through which the plurality of electrical terminals extends, wherein the actuating member includes a plurality of openings through which the plurality of electrical terminals extends, wherein the openings of the TPA member are substantially aligned with openings of actuating member. The opening of the TPA member of this embodiment correspond to the openings of the plate portion. Thus, similar advantages may apply. The openings may facilitate that the one or more electrical terminals can be easily guided through the openings and that the actuating member may be easily moved along the receiving direction.

In a preferred embodiment of the electrical connector assembly, the openings of the TPA member are not circular. This has the advantage that once the terminals are received in the openings of the TPA member, the member can be moved in a lateral direction (referred to as LD in the figures) to provide for locking in the final locked position. Shapes that are not circular may include one or more of the following: triangles, squares, rectangles, pentagons, hexagons, heptagons, octagons, nonagons, decagons, ellipses, parallelograms, trapezoids, rhombi, kites, stars, hearts, crescents, arrowheads, crosses, and diamonds.

In a preferred embodiment of the electrical connector assembly, the assembly is further including one or more terminals and a cover configured to be mounted to the connector housing, thereby covering an outer periphery of the connector housing at least partially, wherein the cover preferably includes one or more openings for guiding the one or more electrical terminals therethrough, wherein, the actuating member is preferably sandwiched between the TPA member and the cover when mounted. The cover may also be configured to cover interior parts of the connector housing at least partially in a mounted condition. Thus, the cover may be a separate part distinct from the actuating member and has a separate and additional function compared to the actuating member. Moreover, the cover may allow for protection against external impacts, such as dirt, dust, moisture, vibration, or the like. This may be the case, as it covers the connector housing and, thereby, the TPA member in its final locked position. Further, the cover may also include openings, shaped similarly as the openings of the actuating member. This may facilitate that the one or more electrical terminals can also be guided through the cover. The cover may include or may be made of a polymer.

A further aspect is related to a method for assembling a connector assembly as described elsewhere herein. The method includes mounting the TPA member to the connector housing; assembling one or more terminals to the connector housing; and moving, preferably by hand, the actuating member from the first position to the second position, so that the TPA member is moved from the pre-locked position to the final locked position.

The method includes all advantages of the electrical connector assembly described herein. Particularly, it is noted that the method as described herein may include all aspects and/or embodiments described herein, even if not expressly described as a method but rather with reference to the electrical connector assembly. It is also to be understood that the features and advantages described with reference to the electrical connector assembly may equally be applicable to the method as described herein.

### BRIEF DESCRIPTION OF THE DRAWINGS

FIG. 1 illustrates an electrical connector assembly according to some embodiments.

FIG. 1A illustrates the electrical connector assembly of FIG. 1 in another assembly step according to some embodiments.

FIG. 1B illustrates electrical connector assembly of FIG. 1 in a further assembly step according to some embodiments.

FIG. 2 illustrates the electrical connector assembly of FIG. 1 in a cross-sectional view from a lateral side according to some embodiments.

FIG. 2A illustrates FIG. 2 in a final locked position according to some embodiments.

FIG. 3 illustrates a frontal view of parts of an electrical connector assembly according to some embodiments.

FIG. 3A illustrates FIG. 3 in a final locked position according to some embodiments.

FIG. 4 illustrates a perspective view of parts of an electrical connector assembly according to some embodiments.

FIG. 4A illustrates a frontal view of FIG. 4 according to some embodiments.

### DETAILED DESCRIPTION

Throughout the present figures and specification, the same reference numerals refer to the same elements. The figures may not be to scale, and the relative size, proportions, and depiction of elements in the figures may be exaggerated for clarity, illustration, and convenience.

It is noted that when features, aspects, and/or embodiments are described herein by the term “substantially”, manufacturing tolerances must be taken into consideration. In this manner, minor deviations during any kind of manufacturing, assembling or the like may pertain. Further, manufacturing tolerances, aging effects, or other minor defects or the like may pertain. These are all encompassed by the term “substantially”. Although not always explicitly expressed by using the term “substantially”, it is understood that the elements, parts, units, shapes, and/or the like described herein may nevertheless include such manufacturing tolerances.

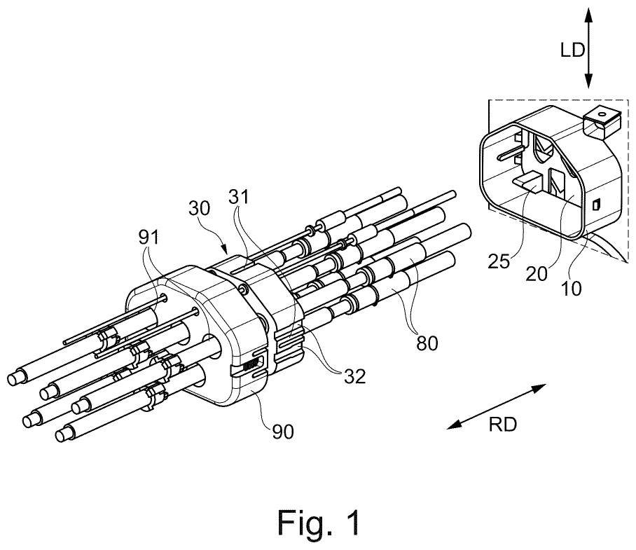

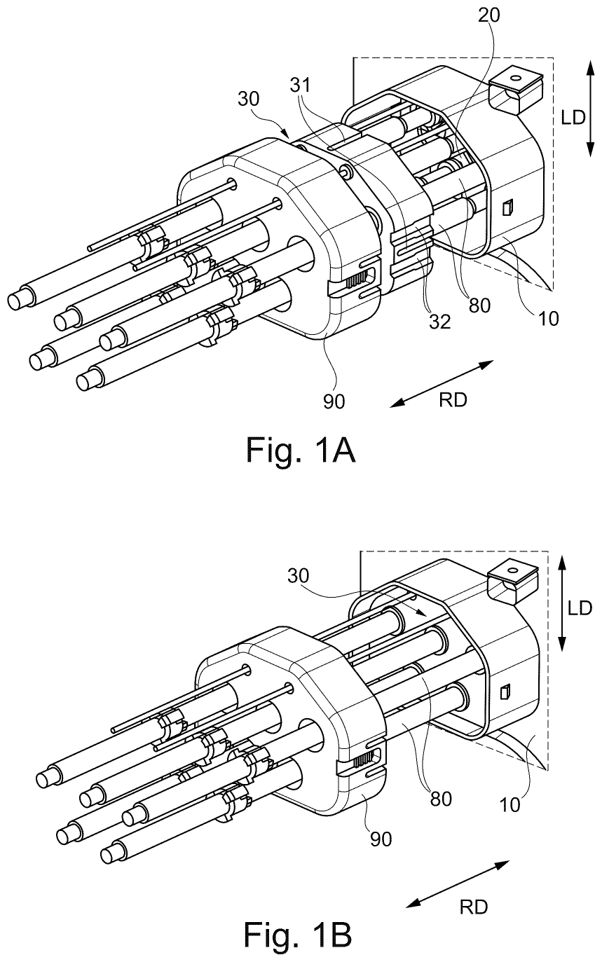

FIGS. 1, 1A, and 1B illustrate an electrical connector assembly 1 according to an embodiment in three different assembly steps. FIG. 1 shows a step in which the terminals 80 are not received in the housing 10. FIG. 1A shows a step in which the terminals 80 are received in the housing 10 and the actuating member 30 is ready to be moved to the second position. FIG. 1B shows a step in which the actuating member 30 is moved into the second position and the TPA member 20 is in the final locked position. The assembly 1 includes a connector housing 10 that can receive terminals 80 (five of which are depicted), a TPA member 20 that is already pre-mounted to the connector housing 20 and that may be in a pre-locked position, and an actuating member 30, which can be a slider. As appreciated, the TPA member 20 is pre-mounted to the housing 20 before the terminals 80 are received.

The actuating member 30 includes one or more openings 34 shaped in correspondence to the one or more electrical terminals 80 such that the movement of the actuating member 30 between first and second position is essentially parallel to the receiving direction RD of the one or more electrical terminals 80.

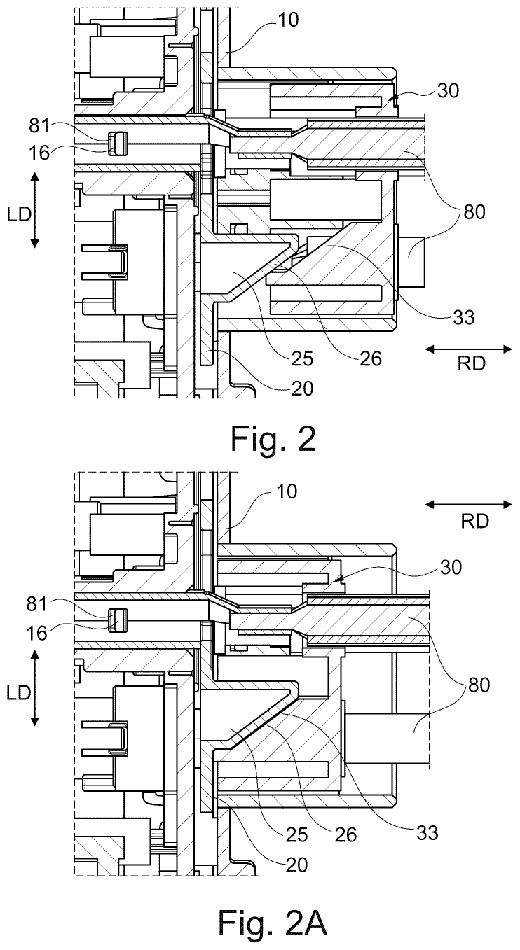

As best seen in FIG. 1B and FIG. 2 (further described below), the assembly 1 includes plurality of electrical terminals 80, wherein the TPA member 20 includes a plurality of openings 27 through which the plurality of electrical terminals 80 extends, wherein the actuating member 30 includes a plurality of openings 34 through which the plurality of electrical terminals 80 extends, wherein the openings 27 of the TPA member 20 are substantially aligned with openings 34 of actuating member 30.

As can be seen, the assembly 1 can also include a cover 90 configured to be mounted to the connector housing 10, thereby at least partially covering an outer periphery of the connector housing 10. The cover 90 can include one or more openings 91 for guiding the one or more electrical terminals 80 therethrough. The actuating member 30 can be sandwiched between the TPA member 20 and the cover 90 when mounted.

The actuating member 30 includes one or more snap elements 32 arranged to engage with one or more apertures arranged at an inner periphery of the connector housing 10. The snap elements 32 are preferably arranged at an end of the actuating member 30 in the receiving direction RD that abuts with the TPA member 20 in the second position.

It may be possible that the actuating member is configured for movement by hand between the first position and the second position. Thus, a user, such as an operator, can access and engage the mounted actuating member and move it between the first position and the second position without the need of much effort. It is appreciated that the TPA member itself does not need to be accessed or engaged by hand of a user to move the TPA member, as it is pre-mounted already in a position ready to be moved by the movement of the actuating member.

As can be seen, the TPA member 20 can cover at least 40%, preferably at least 50%, more preferably at least 60%, more preferably at least 70%, more preferably at least 80% of the frontal area of the electrical connector housing. The frontal area may be substantially perpendicular to the receiving direction RD.

The TPA member 20 may be designed as a small and compact component, as it does not need to be accessed by hand or by any special tool. This may allow more ergonomic operation of the TPA member 20. Further, the design of the TPA member 20 can be optimized to improve water tightness of the electrical connector assembly 1, to improve strength, and/or to improve robustness. This may be the case as the interaction between the TPA member 20 and the actuating member 30 can be well predicted in advance before bringing the TPA member 20 in the final locked position by moving the actuating member 30 from the first position to the second position by moving and/or guiding the actuating member 30 essentially parallel to the receiving direction RD of the one or more electrical terminals 80.

FIGS. 2 and 2A illustrate the embodiment of FIG. 1 in a cross-sectional view from a lateral side. FIG. 2 shows the embodiment in a pre-locked position. FIG. 2 shows the embodiment in a final locked position.

The connector housing 10 includes one or more fixing elements 16 and/or recesses arranged to engage with corresponding recesses 81 and/or fixing elements of the one or more terminals 80, respectively.

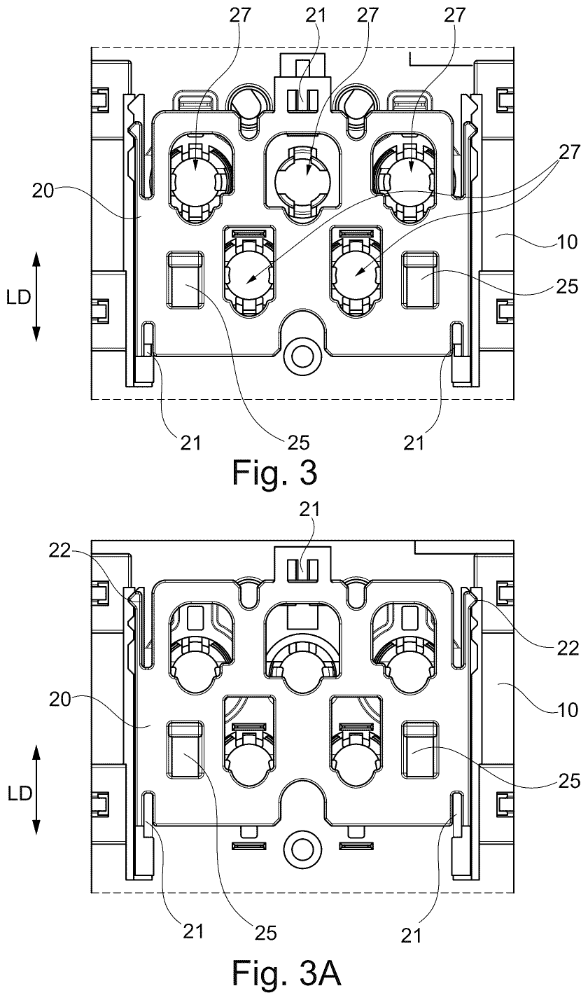

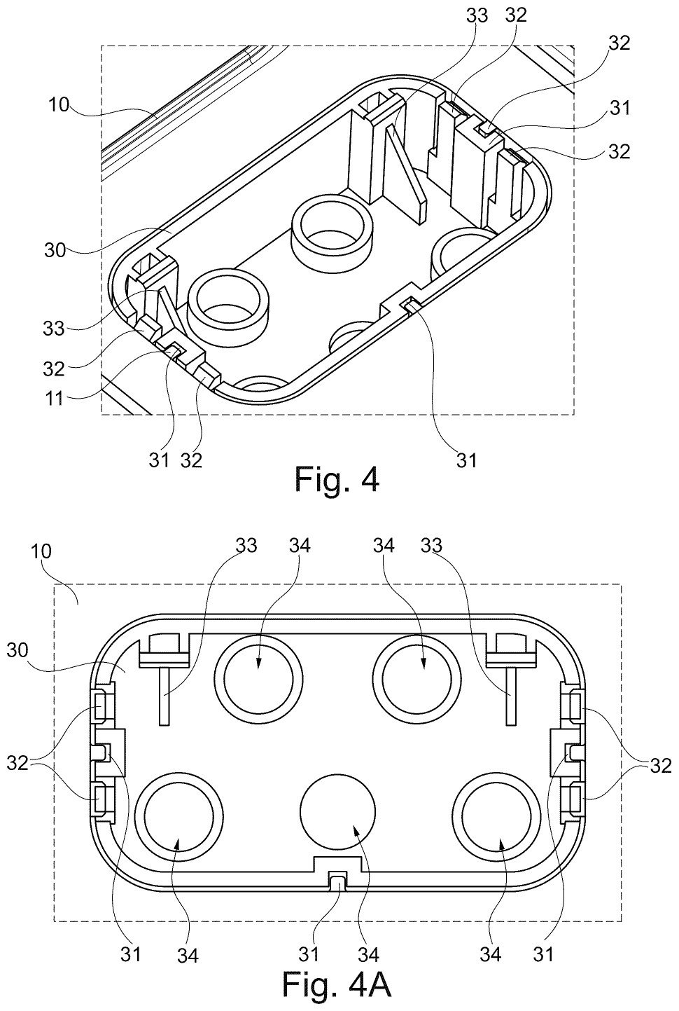

The TPA member 20 includes at least one projection 25. The actuating member 30 includes at least one tapered surface 33 shaped in correspondence to the projection 25 for engaging with the projection 25 when the actuating member 30 is moving between the first position and the second position. As can be seen in FIG. 1, FIG. 3, and FIG. 3A, the TPA member includes two projections 25. Further, as can be seen in FIG. 4 and FIG. 4A, the actuating member 30 includes two tapered surfaces 33. The projection 25 includes a cam surface 26 configured to engage with the tapered surface 33 of the actuating member 30. The cam surface 26 and the tapered surface 33 are inclined with respect to the movement between first and second position of the actuating member 30.

The projection 25 of the TPA member 20 projects in a direction substantially parallel to the receiving direction RD of the one or more electrical terminals 80.

As seen when comparing FIG. 2 and FIG. 2A, the projection 25 of the TPA member 20 is sliding along the tapered surface 33 of the actuating member 30 when the actuating member 30 is moving between the first position and the second position.

FIGS. 3 and 3A illustrate parts of an electrical connector assembly of an embodiment in a frontal view. FIG. 3 shows the embodiment in a pre-locked position. FIG. 3A shows the embodiment in a final locked position.

The TPA member 20 includes at least one sliding means 21 for sliding between the pre-locked position and the final locked position and at least one fixing means 22 for fixing the TPA member 20 to the connector housing 10 in the final locked position. Three sliding means 21 and two fixing means 22 are depicted.

The TPA member 20 has the shape or includes a plate portion that extends in a plane perpendicular to the receiving direction RD of the one or more terminals 80 (as also seen in FIG. 2 and FIG. 2A), the plate portion includes one or more openings 27 configured to receive the one or more electrical terminals 80. The openings 27 can have inner contours configured to interact with a locking contour of the one or more electrical terminals 80 for substantially fixing the one or more electrical terminals 80. As can be seen, the openings 27 of the TPA member 20 are not circular.

FIGS. 4 and 4A illustrate parts of an electrical connector assembly of an embodiment in a perspective view (FIG. 4) and in a frontal view (FIG. 4A).

As can be seen, the actuating member 30 includes one or more guiding rails 31 arranged along the receiving direction RD of the one or more electrical terminals 80 (as also indicated in FIG. 1) to engage with one or more correspondingly shaped guiding protrusions 11 arranged at an inner periphery of the connector housing 10.

A person skilled in the art appreciates that seal members (not indicated in the figures) may be provided to the connector housing 10 for sealing the assembly 1.

In various embodiments of the electrical connector assembly 1 as described in here, it may be possible that, when moving from the second position to the first position the actuating member 30 is configured to move the TPA member 20 from the final locked position to the pre-locked position. This may facilitate that the TPA member 20 could be brought into the pre-locked position in a fast and convenient manner.

It is to be noted that the scope of protection is determined by the claims and is not limited by the embodiments disclosed in the above figures.

While this invention has been described in terms of the preferred embodiments thereof, it is not intended to be so limited, but rather only to the extent assembly forth in the claims that follow. For example, the above-described embodiments (and/or aspects thereof) may be used in combination with each other. In addition, many modifications may be made to configure a particular situation or material to the teachings of the invention without departing from its scope. Dimensions, types of materials, orientations of the various components, and the number and positions of the various components described herein are intended to define parameters of certain embodiments and are by no feature limiting and are merely prototypical embodiments.

Many other embodiments and modifications within the spirit and scope of the claims will be apparent to those of skill in the art upon reviewing the above description. The scope of the invention should, therefore, be determined with reference to the following claims, along with the full scope of equivalents to which such claims are entitled.

The term “and/or” is only an association relationship describing associated objects and represents that three relationships may exist. For example, A and/or B may represent three conditions: i.e., independent existence of A, existence of both A and B and independent existence of B. In addition, the character “/” in the disclosure usually represents that previous and next associated objects form an “or” relationship.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses all possible combinations of one or more of the associated listed items. It will be further understood that the terms “includes,” “including,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. Additionally, while terms of ordinance or orientation may be used herein these elements should not be limited by these terms. All terms of ordinance or orientation, unless stated otherwise, are used for purposes distinguishing one element from another, and do not denote any order of arrangement, order of operations, direction or orientation unless stated otherwise.

1. An electrical connector assembly comprising:
a connector housing configured to receive one or more electrical terminals;
a terminal position assurance (TPA) member configured to be mounted to the connector housing and being movable relative to the connector housing between a pre-locked position and a final locked position when mounted; and
an actuating member configured to be mounted to the connector housing and being movable relative to the connector housing between a first position and a second position when mounted, a movement between first and second position being essentially parallel to a receiving direction of the one or more electrical terminals, the actuating member being configured to move the TPA member from the pre-locked position to the final locked position when the actuating member is moved from the first position to the second position.

2. The electrical connector assembly according to claim 1, wherein the TPA member is configured to be pre-mounted to the connector housing before the one or more electrical terminals are received within the connector housing.

3. The electrical connector assembly according to claim 1, wherein the connector housing comprises one or more fixing elements arranged to engage with corresponding recesses of the one or more terminals.

4. The electrical connector assembly according to claim 1, wherein the connector housing comprises one or more recesses arranged to engage with corresponding fixing elements of the one or more terminals.

5. The electrical connector assembly according to claim 1, wherein the TPA member comprises at least one projection and wherein the actuating member comprises at least one tapered surface shaped in correspondence to the projection for engaging with the projection when the actuating member is moving between the first position and the second position.

6. The electrical connector assembly according to claim 5, wherein the projection comprises a cam surface configured to engage with the tapered surface of the actuating member, wherein the surfaces are inclined with respect to the movement between first and second position.

7. The electrical connector assembly according to claim 5, wherein the projection of the TPA member projects in a direction substantially parallel to the receiving direction of the one or more electrical terminals.

8. The electrical connector assembly according to claim 5, wherein the projection of the TPA member is sliding along the tapered surface of the actuating member when the actuating member is moving between the first position and the second position.

9. The electrical connector assembly according to claim 1, wherein the actuating member comprises one or more openings shaped in correspondence to the one or more electrical terminals such that the movement of the actuating member between first and second position is essentially parallel to the receiving direction of the one or more electrical terminals.

10. The electrical connector assembly according to claim 1, wherein the actuating member comprises one or more guiding rails arranged along the receiving direction of the one or more electrical terminals so as to engage with one or more correspondingly shaped guiding protrusions arranged at an inner periphery of the connector housing.

11. The electrical connector assembly according to claim 1, wherein the TPA member comprises at least one sliding means for sliding between the pre-locked position and the final locked position and at least one fixing means for fixing the TPA member to the connector housing in the final locked position.

12. The electrical connector assembly according to claim 1, wherein the TPA member comprises a plate portion that extends in a plane perpendicular to the receiving direction of the one or more terminals, the plate portion comprising one or more openings configured to receive the one or more electrical terminals.

13. The electrical connector assembly according to claim 12, wherein the openings have inner contours configured to interact with a locking contour of the one or more electrical terminals for substantially fixing the one or more electrical terminals.

14. The electrical connector assembly according to claim 1, wherein the assembly comprises plurality of electrical terminals, wherein the TPA member comprises a plurality of openings through which the plurality of electrical terminals extends, wherein the actuating member comprises a plurality of openings through which the plurality of electrical terminals extends, wherein the openings of the TPA member are substantially aligned with openings of actuating member.

15. The electrical connector assembly of claim 14, wherein the openings of the TPA member are not circular.

16. The electrical connector assembly according to claim 1, further comprising one or more terminals and a cover configured to be mounted to the connector housing, thereby covering an outer periphery of the connector housing at least partially.

17. The electrical connector assembly according to claim 16, wherein the cover comprises one or more openings for guiding the one or more electrical terminals therethrough.

18. The electrical connector assembly according to claim 16, wherein the actuating member is sandwiched between the TPA member and the cover when mounted.

19. A method for assembling a connector assembly having a connector housing configured to receive one or more electrical terminals, a TPA member configured to be mounted to the connector housing and being movable relative to the connector housing between a pre-locked position and a final locked position when mounted, and an actuating member configured to be mounted to the connector housing and being movable relative to the connector housing between a first position and a second position when mounted, a movement between first and second position being essentially parallel to a receiving direction of the one or more electrical terminals, the actuating member being configured to move the TPA member from the pre-locked position to the final locked position when the actuating member is moved from the first position to the second position, the method comprising:
mounting the TPA member to the connector housing;
assembling one or more terminals to the connector housing; and
moving the actuating member from the first position to the second position, so that the TPA member is moved from the pre-locked position to the final locked position.

20. The method according to claim 19, wherein the actuating member is moved from the first position to the second position by hand.
